(19) United States
(12) Patent Application Publication
(10) Pub. No.: US 2006/0085276 A1
(43) Pub. Date: Apr. 20, 2006

(54) Ecommerce methods and systems

(76) Inventors: Johannes Hoech, Redwood City, CA (US); Paul Vatistas, Tahoe City, CA (US)

Correspondence Address: THOMPSON & KNIGHT, L.L.P.;PATENT PROSECUTION GROUP, 1700 PACIFIC AVENUE, SUITE 3300, DALLAS, TX, 75201, US

(21) Appl. No.: 11/124,886

(22) Filed: May 9, 2005

Related U.S. Application Data
(60) Provisional application No. 60/619,468, filed on Oct. 15, 2004.

(51) Int. Cl. G06Q 30/00

(52) U.S. Cl. 705/26

(57) ABSTRACT

A method of conducting business transactions on a networked system includes receiving buyer registration information from a prospective buyer, including information describing a purchasing interest. Seller information is also received which includes information describing an offer being proffered by a prospective seller. At least some of the buyer information describing the purchasing interest and at least some of the seller information describing the offer being proffered are selectively matched. In response to a match, an executable message is transmitted to the prospective buyer with the description of the offer and which allows the prospective buyer to accept or decline the offer.

### CROSS-REFERENCE TO RELATED APPLICATION

This application claims priority to Provisional Application Ser. No. 60/619,468, filed Oct. 15, 2004.

### FIELD OF INVENTION

The present invention relates to wired and wireless e-commerce transactions utilizing Internet- and telephony-based, real-time messaging infrastructures as the proactive transaction and notification media between buyers and sellers.

### BACKGROUND OF INVENTION

By now ecommerce is a well-accepted form of doing business, every year assuming a growing share of the world's overall commercial transaction volume. Numerous e-commerce trading schemes including various forms of supplier networks, on-line market places, auction sites, and small and large sellers' ecommerce sites for conducting business directly with interested buyers. Some industries, such as the travel and the sellers of certain product categories, such as books or CDs, are already heavily trending toward conducting the majority of their transactions over the Internet.

However, the majority of ecommerce activity follows the model of offering wares to a set of browsing potential buyers, the seller then having to wait for a buyer to see the offer(s) and eventually accept it. Even auction sites such as eBay offer a plethora of products from commercial and private sellers to a huge audience of browsing buyers, forcing the seller to wait for enough buyers to accumulate. This system works well for products that have no time urgency. And the onus is very much on a seller to ensure that the market of buyers knows about his or her offering, enticing them to buy if and when the buyers are ready. In other words, the dominant mode of existing ecommerce systems is for sellers to offer their products to the market, and then wait for buyers to see and respond to the seller's product or service offerings.

Online methods for implementing ecommerce transactions are known in the art. Most are seller-centric systems essentially allowing buyers to peruse offered wares, albeit online, analogous to what traditionally has been done in marketplaces or advertisements. Even a few buyer-centric systems exist. However, even these systems and methods are subject to significant disadvantages. One such method is disclosed in U.S. Pat. No. 5,794,207 to Walker et al. for “Method And Apparatus For A Cryptographically Assisted Commercial Network System Designed To Facilitate Buyer-Driven Conditional Purchase Offers” (the '207 patent). Here, a prospective buyer issues a “Conditional Purchase Offer” (i.e. a “CPO”) for a desired product or service, and provides a credit card number or other financial information suitable for closing the contemplated transaction. The CPO can contain many parameters defining the transaction, such as price, time and place of execution, product characteristics (e.g. color, shape, and functionality), and so on. However, once the CPO is issued, an online seller of that product or service then has the right to accept the CPO, thereby obligating the buyer to accept whatever responsive product or service is being offered by the seller within the stated, but limited, parameters of the CPO. The transaction is now complete.

On the other hand, if the prospective buyer's CPO is not accepted within a given time frame, typically only seconds or minutes, the CPO expires, and the buyer must start the process all over again, usually with a new set of parameters, which will be more acceptable to a prospective seller. In the meantime, the buyer must monitor the buyer's terminal until the acceptance or rejection of the offer comes back from the seller.

Hence the method disclosed in the '207 patent is subject to some significant disadvantages. Among other things, once the buyer issues a CPO, the buyer's ability to negotiate with the seller is strictly limited, since acceptance by the seller of the CPO is binding on the buyer. In other words, if the buyer has not carefully considered the parameters of the CPO, that buyer is nonetheless obligated to pay for the requested product or service, normally through an automated debit to the buyer's credit card. Moreover, the short life span of the CPO may make it difficult to secure a willing seller at the same time, especially if conditions in the particular market are temporarily unfavorable. Finally, the currently available process is “hit and miss” and therefore significantly inefficient; a prospective buyer may be forced to issue several revised CPOs until finally a seller agrees to meet the requested conditions. Thus, this system is not truly buyer-centric; it simply affords buyers the ability to make an opening offer, the remainder of the transaction it at the discretion of the sellers.

Given the increasing popularity of online transactions, particularly in a society that demands efficiency in business transactions, new methods and systems of implementing online transactions are required. Such methods and systems should not only be efficient, but also provide more flexibility to both potential buyers and potential sellers.

### SUMMARY OF INVENTION

The principles of the present invention are embodied, for example, in a method of conducting business transactions on a networked system, which includes receiving buyer registration information from a prospective buyer, including information describing a purchasing interest. Seller information is also received which includes information describing an offer being proffered by a prospective seller. At least some of the buyer information describing the purchasing interest and at least some of the seller information describing the offer being proffered are selectively matched. In response to a match, an executable message is transmitted to the prospective buyer with the description of the offer and which allows the prospective buyer to accept or decline the offer.

Embodiments of the present principles augment the previously mentioned dominant mode of ecommerce where sellers wait for perusing buyers in two ways: It not only allows sellers to offer their wares, but it also allows buyers to offer their interests. And it enables buyers and sellers to find one another through an efficient category matching system, as well as to conduct a transaction on the spot by utilizing high-speed, real-time communication infrastructures such as wired or wireless instant messaging, email or automated telephone interactions. In this way, the buyer also can efficiently find a seller, and by each buyer can make his or her purchase category preferences known. As a result, the market of buyers can in aggregate signal to sellers what they are interested in buying. Thus, not only can sellers monitor emerging demand for particular products or services and tailor their offerings accordingly, but once those sellers have found a buyer, they can also offer the buyer the option of conducting a transaction immediately executing pre-defined responses to a push advertisement or alert. This method of allowing sellers reaching interested buyers quickly with instantly executable purchase offers is especially suited to situations in which sellers must rapidly sell off overstock or time-sensitive inventory such as airplane seats, hotel rooms, tickets, or certain product or service specials.

### BRIEF DESCRIPTION OF DRAWINGS

For a more complete understanding of the present invention, and the advantages thereof, reference is now made to the following descriptions taken in conjunction with the accompanying drawings, in which:

FIG. 1 is a high level block diagram of a “Find and Buy” (FNB) system embodying the principles of the present invention;

FIG. 2 is a flow chart illustrating an exemplary transaction process embodying the principles of the present invention;

FIG. 3 is a conceptual diagram of a representative buyer registration computer interface suitable for utilization in the system of FIG. 1;

FIG. 4 is a conceptual diagram of the fields of a representative seller registration interface suitable for utilization in the system of FIG. 1;

FIG. 5 is a conceptual diagram of the display of a buyer terminal suitable for utilization in the system of FIG. 1;

FIG. 6 is high level block diagram illustrating a representative payment method suitable for utilization in the system of FIG. 1; and

FIG. 7 is a chart illustrating a procedure for matching buyers and sellers according to one embodiment of the principles of the present invention.

### DETAILED DESCRIPTION OF THE INVENTION

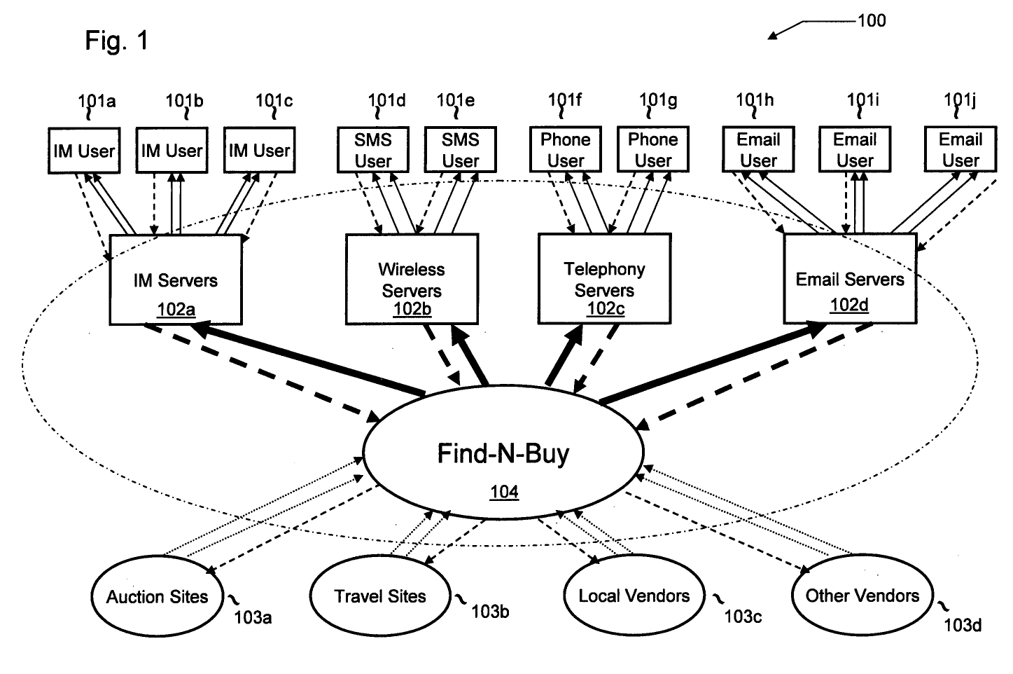

The principles of the present invention and their advantages are best understood by referring to the illustrated embodiment depicted in FIGS. 1-7 of the drawings, in which like numbers designate like parts.

FIG. 1 is a high-level block diagram of a representative ecommerce system 100 suitable for implementing a Find and Buy (FNB) system according to the principles of the present invention. Ecommerce system 100 includes a number of buyer terminals 101a-101i interfacing with associated Internet service provider servers 102a-102d, such as those operated by wired and wireless Internet service providers or telephony carriers, such as America Online (AOL), Microsoft Network (MSN), Yahoo, Verizon, Cingular, Sprint, SBC, and many others. Ecommerce system 100 preferably utilizes instant messaging, although other communications protocols such as email, wireless messaging such as SMS, or telephony-based systems may also be used. Moreover, ecommerce system 100 is implemented, in whole or in part, using wired and wireless Internet connectivity.

Servers 101a-101c in turn communicate with prospective sellers of products and services 103a-103d through a software and hardware FNB portal 104. Prospective sellers include, for example, auctions sites, travel sites, and local, national, and international businesses participating in system 100.

Generally, ecommerce system 100 provides a platform for an FNB transaction system to allow participating sellers to send real-time alerts such as instant or SMS messages to those buyers registered to receive offers for a given category of products or services. Advantageously, system 100 is suitable for handling a large volume of near-simultaneous purchase requests for multiple copies of the same merchandise or service offering for both principal classes of situations, namely where either demand exceeds supply or vice versa.

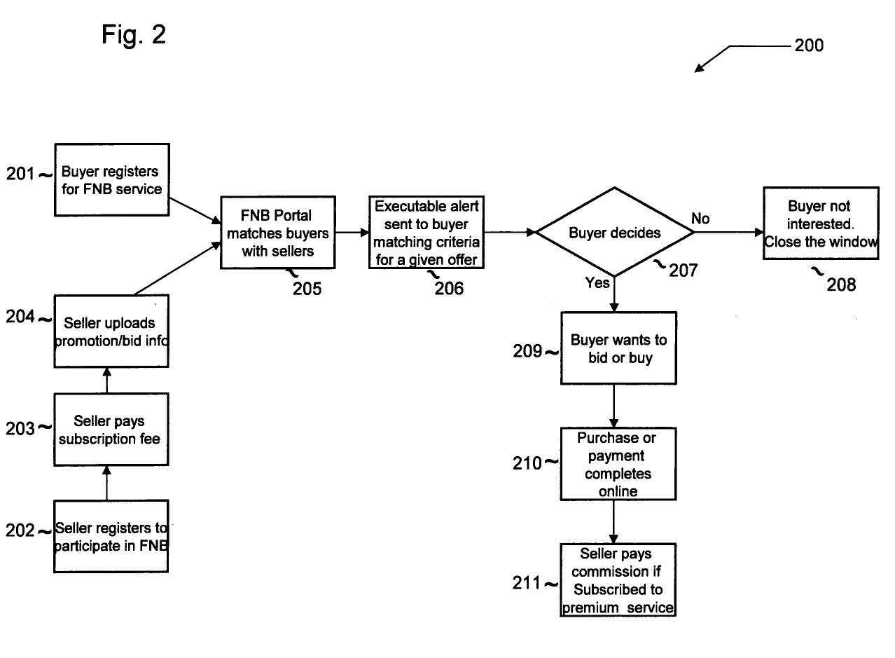

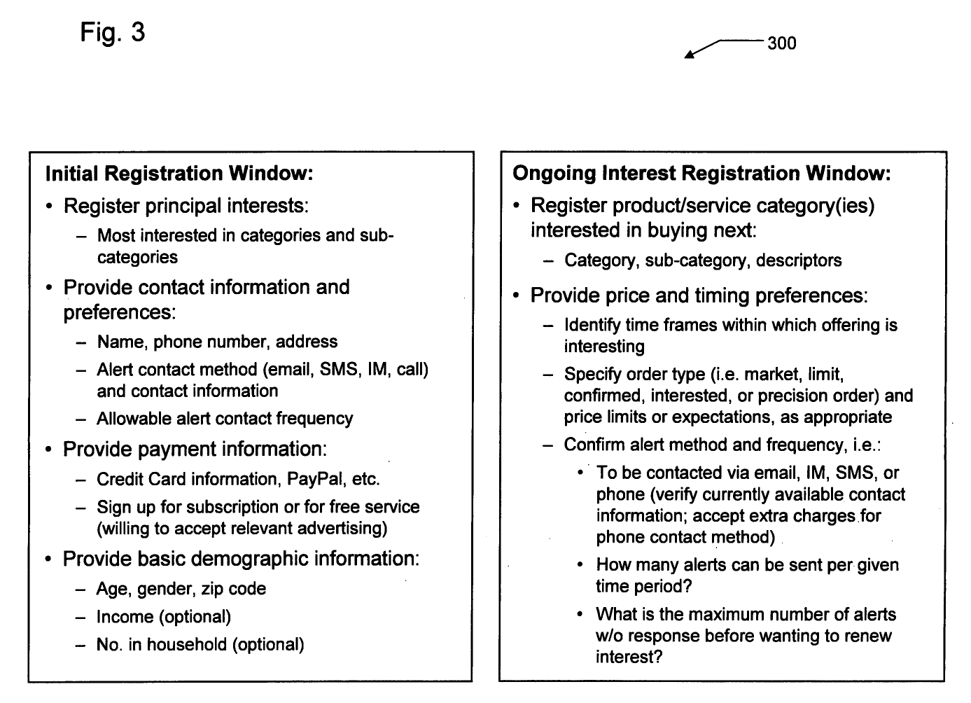

FIG. 2 is a flow chart illustrating a particular procedure 200 for implementing FNB transactions via ecommerce system 100. At block 201, a prospective buyer registers to participate in transactions on ecommerce system 100. FIG. 3 illustrates a representative graphics interface 300, implemented on a corresponding buyer terminal 101a-101i, which provides for the input of the buyer's personal information profiles, and indication of preferred buying interest, information required for establishing and validating a payment method selected by the buyer, and similar registration information. Interface 300 is exemplary only, and may vary in form and information content, as required to efficiently implement customized embodiments of system 100. Buyers may subscribe to participate in ecommerce system 100 by either agreeing to pay regular subscription fees, or by accepting the receipt of targeted advertising in accordance with their stated purchase or general interest profiles. Once registered, prospective buyers can upload information identifying their categories of purchase interest, either on an individual product/service need basis or in bulk, or change or refine the registered information indicating their categories of purchase interest. At this time, prospective buyers also indicate how they wish their purchase interest to be processed by placing different types of purchase orders.

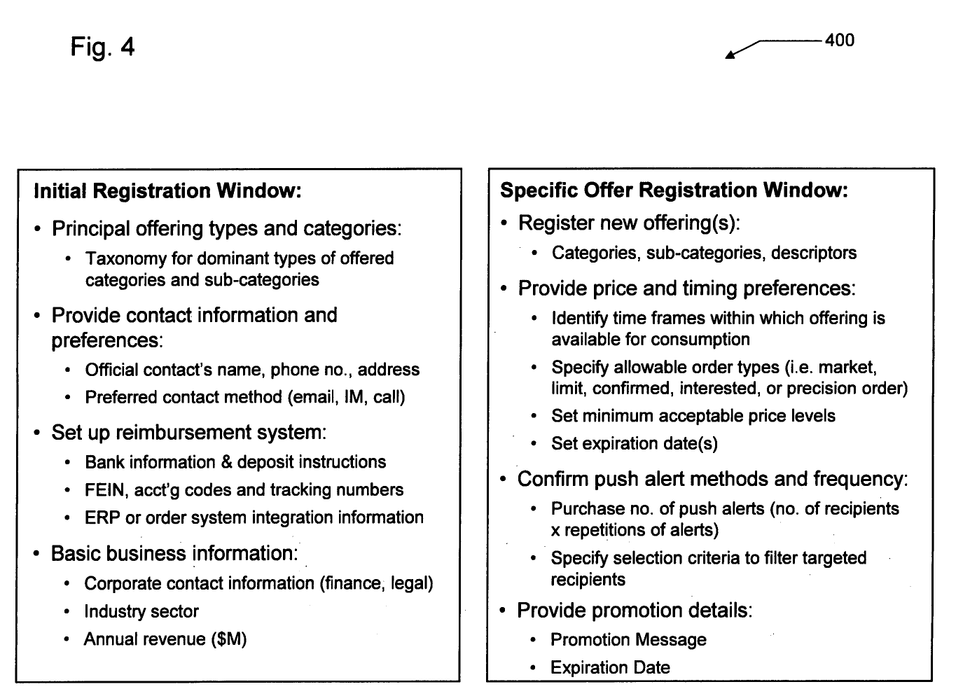

At block 202 of FIG. 2, prospective sellers register for participation in ecommerce system 100. An exemplary seller registration interface 400, including service level selection information, is shown in FIG. 4. Interface 400 is also exemplary, and may vary in actual embodiments of ecommerce system 100. Seller registration terminals effectuate seller registration in the illustrated embodiment of ecommerce system 100, although the principles of the present invention are not necessarily limited thereto. At block 203, the registering seller pays the subscription fee for the service level selected during registration at block 202. The selections include a basic fee, as well as a fee for premium services. The premium service fee includes the basic service fee, along with commissions paid to the operator of ecommerce system 100, and allows the seller access to buyer purchase interest information. In other words, sellers may pay for the ability to sell their products or services through ecommerce system 100 by paying regular subscription fees, an advance bulk fee for being able to send a set number of executable advertising alerts, and/or commissions per conducted transaction. The seller then uploads promotional information for distribution to interested buyers at block 204. Sellers can upload in bulk their product and service offering information, complete with category descriptions, or on an individual product or service basis.

At block 205, FNB portal 104 matches buyers and sellers. In other words, classification system is established that allows buyers to categorize and register what they are interested in buying, and sellers to categorize and register what they are offering, such that both parties can find each other efficiently without an undue amount of type I or type II errors (i.e. offering the wrong category product to a buyer, or omitting to offer the right category product to a buyer).

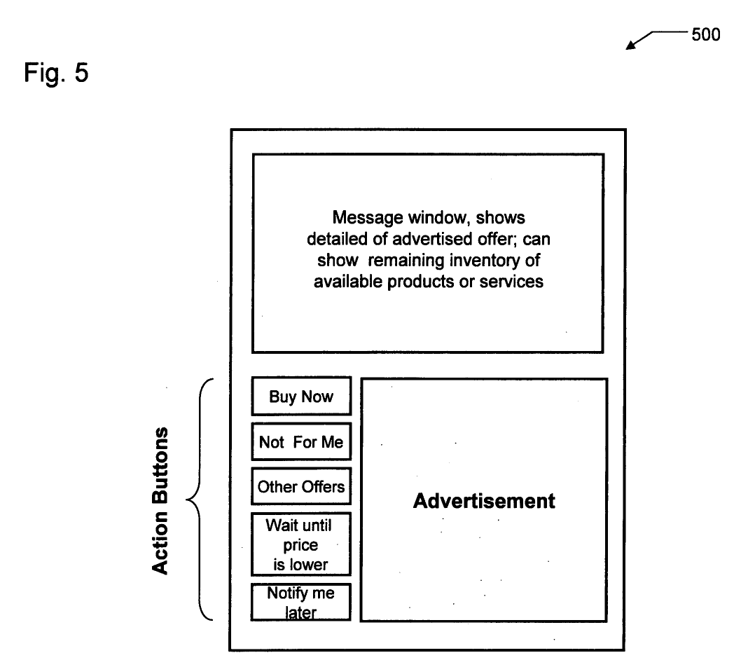

When potential buyers and sellers are matched at block 205, then at block 206, an executable advertising alert, also called “FNB alert” is sent to those registered buyers who, according to their registration information, may be interested in an offer being made available by a matching registered seller. In particular, buyer terminals 101 for the matching potential buyers display an FNB alert that contains standardized transaction options such as “buy now”, “notify me later”, “not interested”, “wait until the price is $______”, and the like that can be transacted via predefined, simple typed responses to the FNB alert, or via hyper-linked “action buttons” within the FNB alert window, depending on how the FNB alert is configured. A representative FNB alert 500 suitable for this purpose is shown in FIG. 5, although the content and form of the FNB alert can vary widely in actual embodiments of ecommerce system 100. One particular feature, which may be offered in the FNB alert, is an information display that allows the buyer to monitor the remaining inventory of available products and services real-time, such that the buyer can evaluate the urgency of initiating a buy transaction.

In procedure 200, a given buyer advantageously has the opportunity at block 207 to make a decision concerning the continuation of any contemplated transaction. In other words, in ecommerce system 100, the buyer is not automatically contractual bound to any offer made by a seller, or even obligated to acknowledge the receipt of a FNB alert. If the buyer decides not to accept a given offer made available through the FNB alert, then at block 208, the FNB alert on the buyer's terminal 101 is simply closed and the potential transaction is over. An additional feature of ecommerce system 100 is the ability of a declining buyer to nonetheless register a strike price at or below which he or she would be willing to purchase the offering. This strike price is then submitted to the seller for further consideration.

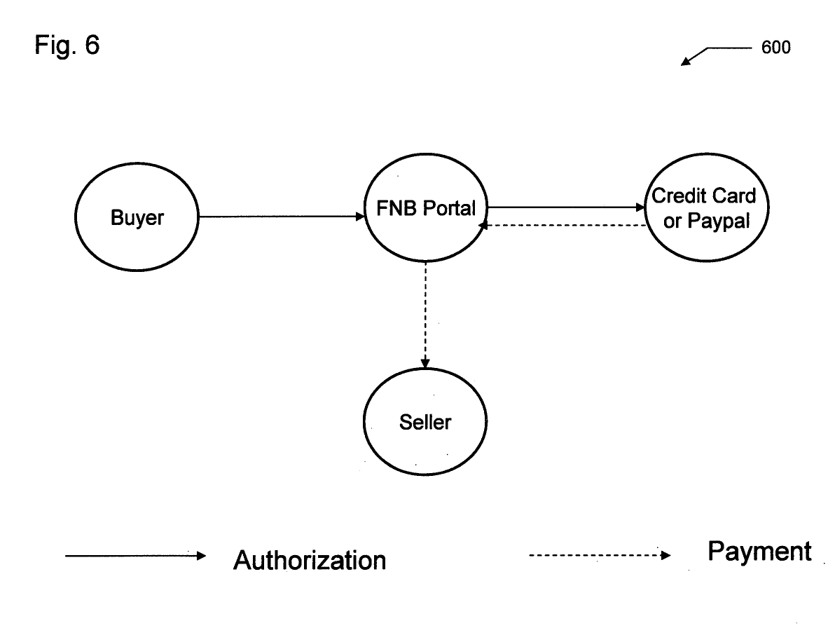

On the other hand, if the prospective buyer decides to initiate a buy transaction at block 207, then the buyer makes the appropriate selection at block 209, for example, by simply choosing the “buy now” option in the FNB alert. This purchase will then also stop the flow of related executable advertising alerts or FNB alerts to the buyer. At block 210, the buyer closes the transaction by authorizing payment by the payment method set-up during buyer registration. FIG. 6 illustrates one possible payment transaction flow. At block 211, the seller is debited for the commission charged by the operator of ecommerce system 100, if the seller has registered for the premium service.

Preferably, the operator of ecommerce system 100 manages the conduct of participating buyers and sellers by a set of ethics and honorable online conduct policies. These policies are enforced, for example, through policy setting, online agreements, and transaction monitoring to ensure buyers commit to paying for purchased offerings and sellers commit to delivering the advertised goods or services on time and to advertised specifications. Ecommerce system 100 also advantageously allows sellers to monitor both existing and emerging demand for a particular product or service category in a market place via a so-called “demand window”, enabling the seller to precisely offer what an emerging, growing group of buyers is looking for. Analogously, a buyer can see the available inventory in the seller's stock of offered products or services in a so-called “supply window” to help decide when to buy an overstock or last minute item and at what price. Buyers also have the option of viewing the still available inventory of an offering via a decrementing counter as part of the received FNB alert. Hence, both sides are provided with substantial information, which further improves the flexibility and usefulness of ecommerce system 100. Additionally, any of the sales transactions between buyers and sellers discussed above can be automated, analogous to “sniping” software, enabling disparate computers to buy and sell products or services automatically under pre-determined conditions utilizing the FNB alerting infrastructure.

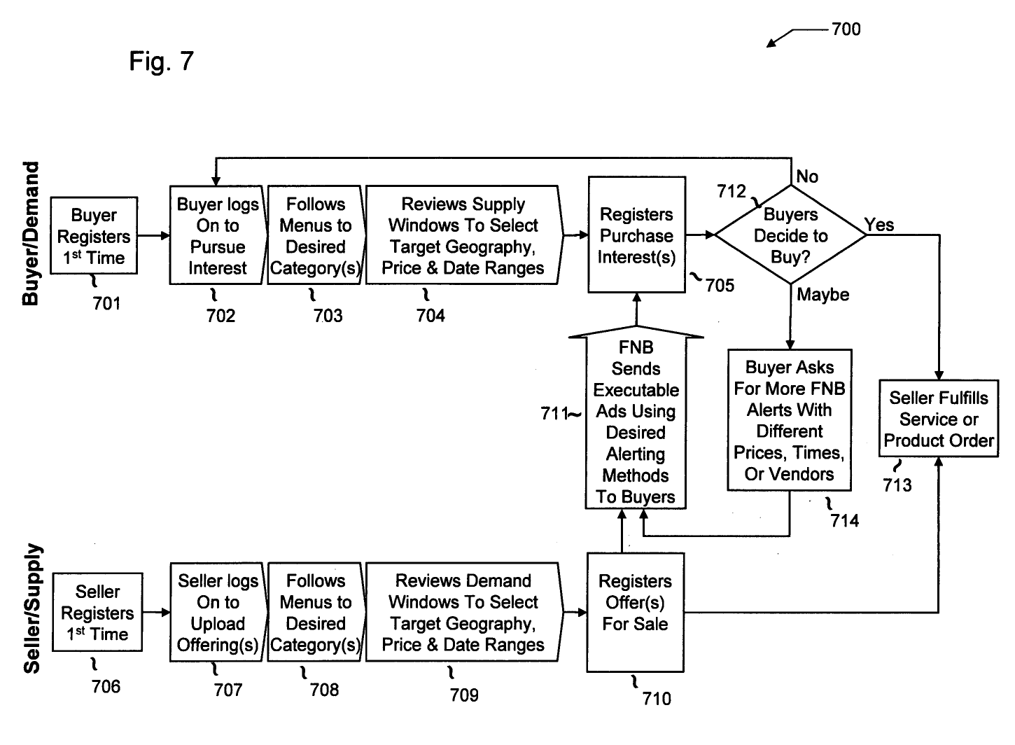

FIG. 7 is a flow chart illustrating another procedure 700 for implementing buy—sell transactions on ecommerce system. Procedure 700 advantageously allows buyers to monitor the supply of a selected category of goods or services and focus on prices, geographical areas, or dates of interest. At the same time, a seller can monitor existing orders, demand, and similar factors such that buyers can be identified that or suitable target candidates for executable ad alerts.

Procedure 700 is based on two pathways, one for buyers and the other for sellers. The buyer path begins at block 701, when the buyer registers for the first time. Once registered at block 701, the buyer may then log on to system 100 at block 702 to pursue a product or service of interest. At block 703, the buyer navigates through the menus appearing on buyer's terminal 101 to find the desired category of products or services. Ecommerce system 100 provides, at block 704, a supply window that allows the buyer to select products or services of interest within a given geographical area, within a given price range, and/or within a given date range. With this information, the buyer can register his or her purchase interests via at block 705.

The seller path of procedure 700 is similar. In this case, the seller initially registers on ecommerce system 100 at block 706, and then may log on anytime at block 707 to upload one or more offerings for products and/or services. In particular, at block 708, the seller follows corresponding demand windows appearing on the seller's terminal 103 such that the seller can review demand information and select selling options such as target geography, prices, and range dates, at block 708. From this information, the seller registers offers for products and/or services on ecommerce system 100 at block 710.

FNB portal 104 matches buyers' purchase interests with sellers' product and service offerings at block 711 and sends executable alerts to the relevant buyers. In particular, a Supply Matching Module matches buyers having a certain set of expectations (e.g. price) with sellers having an identical or similar set of expectations. Initially, buyers and sellers are matched (categorized) by purchase and selling interests. Additionally, any buyers or sellers who have opted out of certain transactions are filtered out of the process. Buyers and sellers are then matched by price. Preferably, the Supply Matching Module maximizes revenue to the sellers by pairing buyers willing to pay the highest price with sellers having the highest asking price. For example, buyers can be ranked in decreasing order of maximum acceptable purchase price and sellers similarly ranked in order of minimal acceptable selling price. From the rankings, buyers listing the highest acceptable purchase price are matched with sellers listing the highest minimum acceptable sales price. An alert can then be sent to the matching buyer or buyers. Moreover, when demand exceeds supply, buyers receiving an executable alert may be limited to those who have the listed the highest acceptable sales price. On the other hand, if supply exceeds demand, then Supply Matching Module attempts to match the seller's highest priced inventory with the highest acceptable buyer price, in order to clear inventory. At decision block 712, a buyer receiving an executable alert is given the option to either decline an offer straightaway, accept the offer straightaway, or ask for additional executable alerts with different prices, times, or vendors. If the buyer accepts an offer, then at block 713, the buyer is debited through the registered payment method and the seller fulfills the order by delivery of the product or services.

When the buyer requests additional executable alerts, one or more sellers on system 100 can respond with modified offer. In essence, system 100 allows buyers and sellers to engage in on-line negotiation. For example, a buyer can issue an “initial interest”, asking for an additional alert when a product or service offering meets certain conditions (e.g., the price reaches a specified level). Or a buyer can ask for automatically executed transactions by agreeing to irrevocably purchase an offering once his or her conditions are met. A buyer will also define the period of time for which an order is valid (e.g. one day, one week, or one month), or as good until canceled; in all cases, unless otherwise specified, an order is canceled once an associated purchase has been made.

In implementing procedure 100, FNB portal 104 periodically checks for updates in both buyers' and seller's listings, which may result for matches. In addition, sellers are sent updated information concerning the number of transactions executed, as well as the number and rank of counteroffers being made buy prospective purchasers. Hence, a seller can evaluate the market for a given product or service and make an informed decision as to modifying an offer to meet market demand.

In sum, the principles of the present invention are embodying in systems and methods that provide flexibility to the buyer. Among other things, the buyer is not bound by a counteroffer made by a seller on the system, unless the buyer specifically requests that a transaction be executed when certain conditions are met. These principles also allow both buyers and sellers to monitor both supply and demand and appropriately modify their requests and offers as conditions change. In other words, a system is created that allows both parties to engage in a kind of electronic negotiation based on supply and demand.

Although the invention has been described with reference to specific embodiments, these descriptions are not meant to be construed in a limiting sense. Various modifications of the disclosed embodiments, as well as alternative embodiments of the invention, will become apparent to persons skilled in the art upon reference to the description of the invention. It should be appreciated by those skilled in the art that the conception and the specific embodiment disclosed might be readily utilized as a basis for modifying or designing other structures for carrying out the same purposes of the present invention. It should also be realized by those skilled in the art that such equivalent constructions do not depart from the spirit and scope of the invention as set forth in the appended claims.

It is therefore contemplated that the claims will cover any such modifications or embodiments that fall within the true scope of the invention.

What is claimed is:

1. A method of conducting business transactions on a networked system comprising:
receiving buyer information from a prospective buyer describing a purchasing interest;
receiving seller information from a prospective seller describing an offer being proffered by the prospective seller;
selectively matching at least some of the buyer information describing the purchasing interest and at least some of the seller information describing the offer being proffered; and
in response to matching, transmitting an executable message to the prospective buyer with the description of the offer; and
allowing the prospective buyer to accept or decline the offer.

2. The method of claim 1, further comprising:
receiving an executable message from the prospective buyer accepting the offer;
automatically debiting the prospective buyer through a payment option provided as part of the buyer information; and
notifying the prospective seller that a sale has been made.

3. The method of claim 1, wherein selectively matching comprises:
entering the buyer information on a buyer list including buyer information from plurality of prospective buyers;
entering the seller information on a seller list including seller information from a plurality of prospective sellers; and
comparing the buyer list and the seller list to match the prospective buyer and the prospective seller.

4. The method of claim 3, wherein the buyer information entries on the buyer list include a maximum acceptable purchase price and the seller information entries on the seller list include a minimum acceptable sales price and comparing the buyer and seller lists comprises comparing the maximum acceptable purchase prices and the minimum acceptable sales prices to match the prospective seller and the prospective buyer.

5. The method of claim 4, further comprising:
ranking entries on the buyer list by maximum acceptable purchase price;
ranking entries on the seller list by minimum acceptable sales price; and
comparing the rankings of the buyer and seller lists to match a prospective buyer having the highest maximum acceptable purchase price with a prospective seller having the highest minimum acceptable sales price.

6. The method of claim 3 wherein a selected buyer information entry on the buyer list includes an identification of order type selected from the group consisting of market, limit, precision, interested, and confirmed orders.

7. The method of 3, further comprising:
allowing the prospective seller to view the buyer list; and
receiving new seller information from the prospective buyer for entry on the seller list in response.

8. The method of claim 1, wherein the executable message comprises an instant message transmitted across the networked system.

9. The method of claim 1, wherein a portion of the networked system is wireless.

10. A transaction system for implementing online sales between prospective buyers and sellers and operable to:
receive buyer information from the prospective buyers describing purchasing interests;
receive seller information describing offers being made by the prospective sellers;
categorize the purchasing interests and the offers;
selectively match purchasing interests of the prospective buyers and offers of the prospective sellers by category; and
in response to a match in a category, selectively match prospective buyers and sellers within the matching category by a maximum buy price included in the corresponding buyer information and a minimum sell price included in the corresponding seller information.

11. The system of claim 10, wherein the system is further operable in response to a match by price, to transmit an executable instant message to a matching prospective buyer with the description of the offer from a matching prospective seller.

12. The system of claim 11, wherein the system if further operable in response to the executable instant message to receive an acceptance from the matching prospective buyer and automatically initiate a sale between the prospective buyer and the matching prospective seller.

13. The system of claim 1 0, wherein the system if further operable to:
in response to a match of a maximum buy price included in corresponding buyer information and a minimum sell price included in the corresponding seller information, check the buyer information for conditions on closing the sale; and
selectively automatically close the sale between the matching prospective buyer and the matching prospective seller when allowed by the conditions on closing the sale.

14. The system of claim 13, wherein the system selectively automatically closes the sale when the maximum buy price is a prevailing market price.

15. The system of claim 13, wherein the system selectively automatically closes the sale when the minimum selling price is at or below the maximum buy price.

16. The method of claim 11, further comprising:
receiving in response to the instant message a counteroffer from the matching prospective buyer; and
transmitting the counteroffer to the matching prospective seller.

17. The method of claim 11, further comprising receiving a request for additional information from the matching prospective buyer in response to the executable instant message.

18. The method of claim 11, further comprising automatically debiting the matching buyer utilizing a payment method authorized in the corresponding buyer information.

19. The method of claim 11, further comprising automatically debiting the matching seller a commission for closing the transaction.
